(19) United States
(12) Patent Application Publication
(10) Pub. No.: US 2006/0088762 A1
(43) Pub. Date: Apr. 27, 2006

(54) Non-aqueous electrolyte battery

(75) Inventor: Tomohito Okamoto, Uji-shi (JP)

Correspondence Address: DARBY & DARBY P.C., P. O. BOX 5257, NEW YORK, NY, 10150-5257, US

(73) Assignees: Sanyo Electric Co., Ltd., Moriguchi-shi (JP); Sanyo GS Soft Energy Co., Ltd., Kyoto-shi (JP)

(21) Appl. No.: 11/249,801

(22) Filed: Oct. 12, 2005

(30) Foreign Application Priority Data
Oct. 21, 2004 (JP) 2004-307227

(51) Int. Cl. H01M 2/16; H01M 2/08

(52) U.S. Cl. 429/142; 429/185

(57) ABSTRACT

In a non-aqueous electrolyte battery including a generating element having a separator bonded with an adhesive layer between a positive electrode plate and a negative electrode plate, the adhesive layer contains a fluorine-based polymer having a mass average molecular weight of from 500,000 to 1,500,000 and a melting point of from 165° C. to 175° C., and an inorganic-solid filler. The fluorine-based polymer is a polyvinylidene fluoride-based polymer such as a polyvinylidene fluoride homopolymer.

### CROSS-REFERENCE TO RELATED APPLICATION

This non-provisional application claims priority under 35 U.S.C. §119(a) on Patent Application No. 2004-307227 filed in Japan on Oct. 21, 2004, the entire contents of which are hereby incorporated by reference.

### BACKGROUND OF THE INVENTION

1. Field of the Invention

The present invention relates to a non-aqueous electrolyte battery in which a separator is bonded with an adhesive layer between a positive electrode plate and a negative electrode plate.

2. Description of Related Art

In a polymer electrolyte battery including a polymerized electrolyte in a battery case, such as between the positive and negative electrodes and a separator as a separating member, since the polymerized electrolyte makes it possible to easily hold an electrolyte solution, a leakage of solution is unlikely to occur. Moreover, since the polymerized electrolyte has the function of bonding the electrode and the separator together, it is possible to reduce shrinkage of the separator when abnormality such as heat or overcharge occurs, thereby improving safety.

However, when an electrolyte is polymerized, the ionic conductivity tends to decrease and polarization tends to be larger compared with a non-polymerized electrolyte, and particularly the cycle life characteristic and low-temperature discharge characteristic tend to be ill-affected. Therefore, there was proposed a battery capable of reducing the decrease in the ionic conductivity and ensuring discharge performance by mixing an inorganic solid filler into an electrolyte and polymerizing the electrolyte (see, for example, PCT International Publication No. 99/36981).

In recent years, with the development of small-size or high-performance electronic equipment such as cellular phones or PDA (Personal Digital Assistant), there is an increasing demand for batteries with high-energy density for use as the power source of the above-mentioned electronic equipment. However, it is difficult to ensure discharge performance and further satisfy requirements for safety, etc.

### BRIEF SUMMARY OF THE INVENTION

The present invention has been made with the aim of solving the above problem, and it is an object of the present invention to provide a non-aqueous electrolyte battery capable of improving safety while ensuring discharge performance by causing an adhesive layer to contain a fluorine-based polymer having a mass average molecular weight (weight average molecular weight) of from 500,000 to 1,500,000 and a melting point of from 165° C. to 175° C., and an inorganic solid filler.

Another object of the invention is to provide a non-aqueous electrolyte battery capable of reducing the degradation of discharge performance of the battery by using a polyvinylidene fluoride-based polymer as a fluorine-based polymer.

Still another object of the invention is to provide a non-aqueous electrolyte battery capable of reducing the degradation of discharge performance of the battery more satisfactorily by using a polyvinylidene fluoride homopolymer as a polyvinylidene fluoride-based polymer.

A non-aqueous electrolyte battery according to a first aspect of the invention is a non-aqueous electrolyte battery in which a separator is bonded with an adhesive layer between a positive electrode plate and a negative electrode plate, and characterized in that the adhesive layer contains a fluorine-based polymer having a mass average molecular weight of from 500,000 to 1,500,000 and a melting point of from 165° C. to 175° C., and an inorganic solid filler.

A non-aqueous electrolyte battery according to a second aspect of the invention is based on the first aspect, and characterized in that the fluorine-based polymer is a polyvinylidene fluoride-based polymer.

A non-aqueous electrolyte battery according to a third aspect of the invention is based on the second aspect, and characterized in that the polyvinylidene fluoride-based polymer is a polyvinylidene fluoride homopolymer.

In the first aspect, since the melting point of the fluorine-based polymer contained in the adhesive layer is between 165° C. and 175° C., the adhesive layer is not easily broken even at high temperatures and can maintain the adhesive effect. It is therefore possible to reduce shrinkage of the separator at high temperatures and improve safety. Moreover, since the mass average molecular weight (weight average molecular weight) of the fluorine-based polymer contained in the adhesive layer is between 500,000 and 1,500,000, the adhesiveness between the electrode plate and the separator increases, and it is possible to reduce shrinkage of the separator and improve the safety of the battery. Note that when the mass average molecular weight is smaller than or equal to 500,000, the adhesiveness decreases. When the mass average molecular weight is larger than or equal to 1,500,000, the viscosity is too high, and it is difficult to form an even adhesive layer. Further, since the adhesive layer contains the inorganic solid filler, it is possible to easily ensure porosity in the adhesive layer, and it is possible to reduce the decrease in the ion conductivity and reduce the degradation of discharge performance of the battery. In addition, the fluorine-based polymer of the adhesive layer has high safety in an electrolyte solution in the battery, and is stable against oxidation or reduction of the positive electrode or the negative electrode.

In the second aspect, since a polyvinylidene fluoride-based polymer is used as a fluorine-based polymer, it is possible to easily ensure porosity in the adhesive layer, and it is possible to reduce the decrease in the ion conductivity and reduce the degradation of discharge performance of the battery.

In the third aspect, since a polyvinylidene fluoride homopolymer is used as a polyvinylidene fluoride-based polymer, it is possible to easily form a crystalline layer and easily ensure porosity in the adhesive layer, and it is possible to reduce the decrease in the ion conductivity and reduce the degradation of discharge performance of the battery more satisfactorily.

According to the first aspect, it is possible to improve safety while ensuring the discharge performance.

According to the second and third aspects, it is possible to reduce the degradation of discharge performance of the battery.

The above and further objects and features of the invention will more fully be apparent from the following detailed description with accompanying drawings.

### BRIEF DESCRIPTION OF THE SEVERAL VIEWS OF THE DRAWINGS

FIG. 1 is an exploded perspective view showing an example of a non-aqueous electrolyte battery according to the present invention; and

FIG. 2 is a table showing the test results of examples and comparative examples.

### DETAILED DESCRIPTION OF THE INVENTION

The following description will specifically explain the present invention, based on the drawings illustrating an embodiment thereof.

### EXAMPLE 1

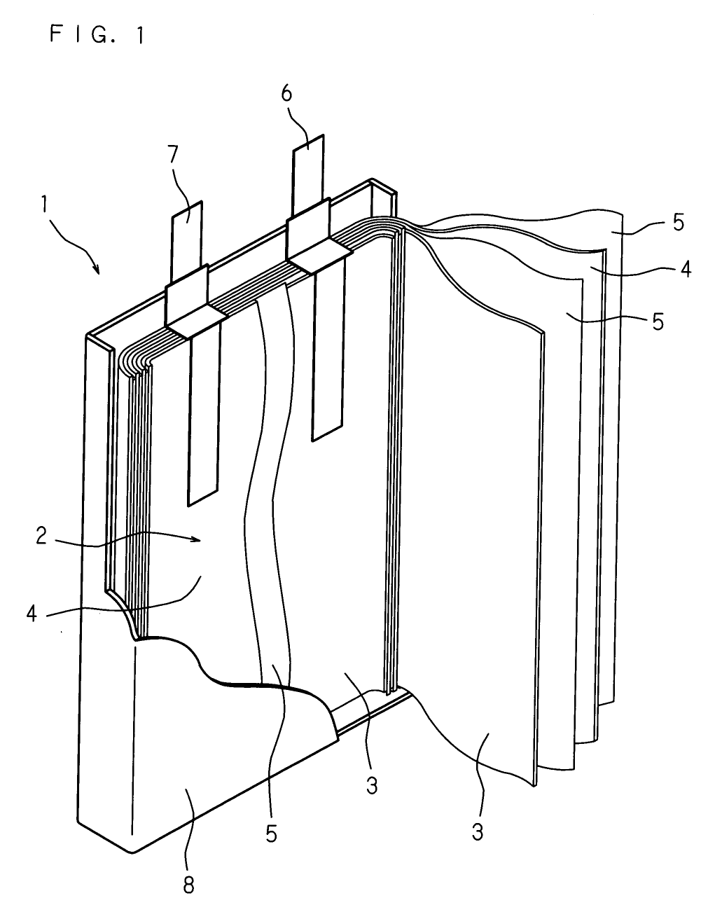

FIG. 1 is an exploded perspective view showing an example of a non-aqueous electrolyte battery according to the present invention. In FIG. 1, the reference numeral 1 is a non-aqueous electrolyte battery (hereinafter referred to as the battery), the reference numeral 2 is a generating element, the reference numeral 3 is a positive electrode plate, the reference numeral 4 is a negative electrode plate, the reference numeral 5 is a separator, the reference numeral 6 is a positive terminal, the reference numeral 7 is a negative terminal, and the reference numeral 8 is a battery case.

For the positive electrode plate 3, slurry was prepared by mixing 94% by mass of lithium cobaltoxide as an active material, 3% by mass of acetylene black as a conductive agent and 3% by mass of polyvinylidene fluoride as a binding agent together and dispersing the mixture into N-methyl-2-pyrrolidone (NMP). This slurry was evenly applied onto a 15 μm thick aluminum foil collector and dried, and then compression-molded with a roll press to produce the positive electrode plate 3.

For the negative electrode plate 4, negative slurry was prepared by adjusting the amount of PVDF as a binder to be 5% by mass with respect to 95% by mass of graphite powder, adding NMP and mixing them. This negative slurry was evenly applied onto a 10 μm thick copper foil collector and dried, and then compression-molded with a roll press to produce the negative electrode plate 4.

For the separator 5, a 16 μm thick micro-porous polyethylene film was used. Slurry was prepared by adding Al₂O₃ as an inorganic solid filler into a material formed by dissolving a polyvinylidene fluoride homopolymer (PVDF) having a mass average molecular weight (weight average molecular weight) of 500,000 and a melting point of 173° C. in N-methyl pyrrolidone, and the viscosity of the slurry was adjusted by further adding N-methyl pyrrolidone. This slurry was applied onto the separator 5 to form an adhesive layer, and the separator 5 with the adhesive layer was wound together with the positive electrode plate 3 and negative electrode plate 4 to obtain the generating element 2.

The wound generating element 2 was vacuum-dried at 100° C. for 12 hours to remove N-methyl pyrrolidone. Next, after wrapping the dried generating element 2 in the battery case 8 made of a 90 μm thick aluminum laminated film, it was impregnated with an electrolyte solution prepared by dissolving 1 mol/l of LiPF₆ in mixture solvent of ethylene carbonate and diethyl carbonate (volume ratio: 1:2), and then the laminate film was sealed by welding to produce a battery. Note that the electrolyte solution is held in the entire generating element 2 including the adhesive layer. Moreover, the capacity of the battery is 800 mAh.

### EXAMPLE 2

A battery similar to Example 1, except that the mass average molecular weight of the polymer of the adhesive layer was 800,000, was produced.

### EXAMPLE 3

A battery similar to Example 1, except that the mass average molecular weight of the polymer of the adhesive layer was 1,200,000, was produced.

### EXAMPLE 4

A battery similar to Example 1, except that the mass average molecular weight of the polymer of the adhesive layer was 1,500,000 and the melting point was 172° C., was produced.

### EXAMPLE 5

A battery similar to Example 1, except that the mass average molecular weight of the polymer of the adhesive layer was 1,200,000 and the melting point was 165° C., was produced.

### EXAMPLE 6

A battery similar to Example 1, except that the mass average molecular weight of the polymer of the adhesive layer was 1,200,000 and the melting point was 170° C., was produced.

### EXAMPLE 7

A battery similar to Example 1, except that the mass average molecular weight of the polymer of the adhesive layer was 1,200,000 and the melting point was 175° C., was produced.

### EXAMPLE 8

A battery similar to Example 1, except that the polymer of the adhesive layer was a copolymer of vinylidene fluoride and hexafluoropropylene (P(VDF/HFP)) and had a mass average molecular weight of 1,200,000 and a melting point of 166° C., was produced.

### EXAMPLE 9

A battery similar to Example 1, except that the polymer of the adhesive layer was a copolymer of vinylidene fluoride and chlorotrifluoroethylene (P(VDF/CTFE)) and had a mass average molecular weight of 1,200,000 and a melting point of 167° C., was produced.

### EXAMPLE 10

A battery similar to Example 3, except that the inorganic solid filler of the adhesive layer was TiO₂, was produced.

### EXAMPLE 11

A battery similar to Example 3, except that the inorganic solid filler of the adhesive layer was SiO₂, was produced.

### COMPARATIVE EXAMPLE 1

A battery similar to Example 1, except that the mass average molecular weight of the polymer of the adhesive layer was 350,000 and the melting point was 174° C., was produced.

### COMPARATIVE EXAMPLE 2

A battery similar to Example 1, except that the mass average molecular weight of the polymer of the adhesive layer was 1,700,000 and the melting point was 171° C., was produced.

### COMPARATIVE EXAMPLE 3

A battery similar to Example 1, except that the mass average molecular weight of the polymer of the adhesive layer was 500,000 and the melting point was 163° C., was produced.

### COMPARATIVE EXAMPLE 4

A battery similar to Example 1, except that the polymer of the adhesive layer was a copolymer of vinylidene fluoride and hexafluoropropylene (P(VDF/HFP)) and had a mass average molecular weight of 1,200,000 and a melting point of 159° C., was produced.

### COMPARATIVE EXAMPLE 5

A battery similar to Example 1, except that the polymer of the adhesive layer was a copolymer of vinylidene fluoride and hexafluoropropylene (P(VDF/HFP)) and had a mass average molecular weight of 500,000 and a melting point of 157° C., was produced.

### COMPARATIVE EXAMPLE 6

A battery similar to Example 3, except that the polymer of the adhesive layer was a polyvinylidene fluoride homopolymer (PVDF) and did not contain the inorganic solid filler, was produced.

### COMPARATIVE EXAMPLE 7

A battery similar to Example 1, except that the polymer of the adhesive layer was a copolymer of vinylidene fluoride and hexafluoropropylene (P(VDF/HFP)), had a mass average molecular weight of 1,200,000 and a melting point of 166° C., and did not contain the inorganic filler, was produced.

On the batteries of the above-mentioned examples and comparative examples, cycle life tests and overcharge tests were conducted. The cycle life test was conducted by repeating 500 cycles of charge and discharge, one cycle consisting of performing constant-current and constant-voltage charge for 3 hours at a current of 800 mA until the voltage reached 4.2 V under the environment of 25° C. and then performing constant-current discharge at a current of 800 mA until the voltage reached 2.75V Next, the capacity retention ratio that is the ratio of the discharge capacity at the 500th cycle to the discharge capacity at the 1st cycle (=100×“discharge capacity at 500th cycle”/“discharge capacity at 1st cycle”[%]) was found. Three batteries for the respective examples and the respective comparative examples were tested, and the average value of the three batteries was used.

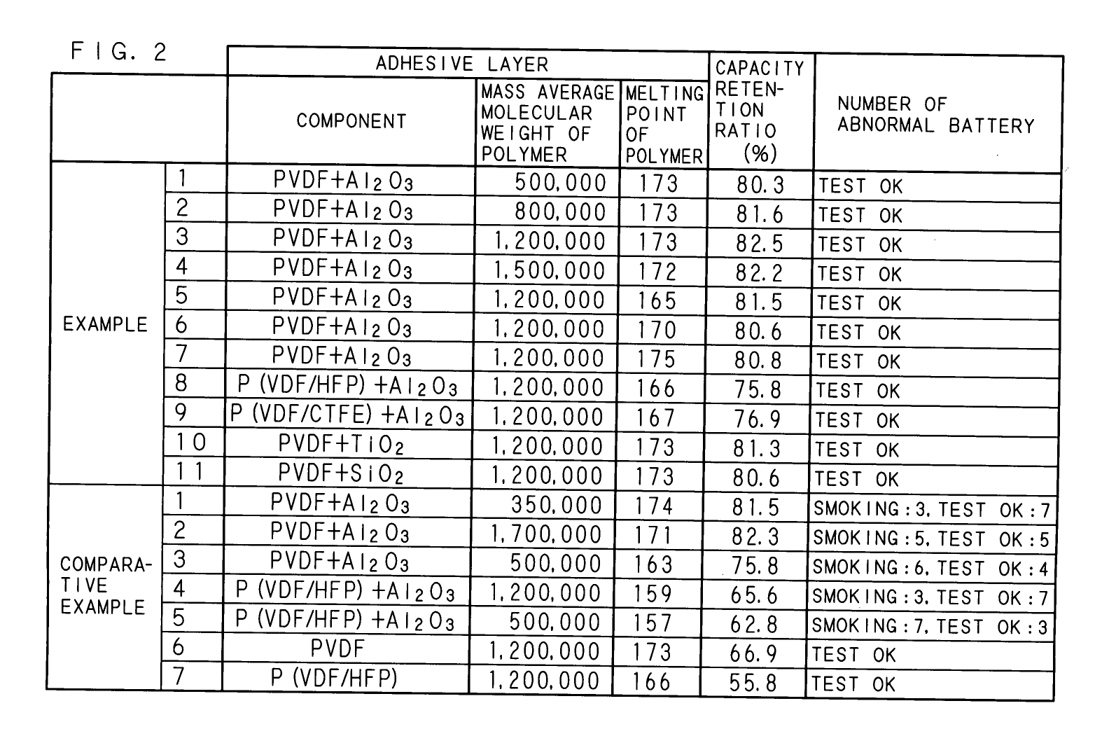

In the overcharge test, after performing constant-current and constant-voltage charge for 3 hours at a current of 800 mA until the voltage reached 4.2 V, overcharge is performed at a current of 2 A for 3 hours, and then the number of batteries in which abnormality such as abnormal heat occurred during overcharge was recorded. Ten batteries for the respective examples and the respective comparative examples were tested. The test results are shown in FIG. 2.

In Examples 1 through 11 in which the adhesive layer contains an inorganic solid filler and a fluorine-based polymer, and the mass average molecular weight of the polymer is between 500,000 and 1,500,000 and the melting point is between 165° C. and 175° C., both of the cycle life characteristic (capacity retention ratio) and safety (the number of abnormal batteries) during overcharge are satisfactory.

As shown in Comparative Example 1, when the mass average molecular weight of the polymer was 350,000, three batteries had abnormality (smoking). When the mass average molecular weight of the polymer is small, the bonding strength between the electrode plate and the separator is weak. Therefore, with an increase in temperature in the battery during overcharge, a short-circuit may be caused by shrinkage of the separator and a break in the film, and may cause a trouble. The mass average molecular weight of the polymer of the adhesive layer needs to be larger than or equal to 500,000.

Moreover, as shown in Comparative Example 2, when the mass average molecular weight of the polymer was 1,700,000, abnormality (smoking) occurred in five batteries. When the molecular weight of the polymer is large, since the viscosity of the polymer dissolved in a solvent such as N-methyl pyrrolidone is too high, an even adhesive layer cannot be formed, and there is a portion where the adhesive layer is not bonded to the electrode plate and the separator. Therefore, when the battery is overcharged, shrinkage of the separator or a break in the film due to heat occurs at the above-mentioned portion, and a trouble occurs. The mass average molecular weight of the polymer of the adhesive layer needs to be smaller than or equal to 1,500,000.

Further, as shown in Examples 5, 8 and 9, Example 5 using a polyvinylidene fluoride homopolymer (PVDF) has better cycle life characteristic (capacity retention ratio) than Example 8 using a copolymer of vinylidene fluoride and hexafluoropropylene (P(VDF/HFP)) and Example 9 using a copolymer of vinylidene fluoride and chlorotrifluoroethylene (P(VDF/CTFE)). As the polymer of the adhesive layer, it is preferable to use a polyvinylidene fluoride homopolymer (PVDF) that can easily form a porous layer.

As shown in Comparative Examples 3 through 5, when the melting points of the polymers of the respective adhesive layers were 163° C., 159° C., and 157° C., abnormality (smoking) occurred in six batteries, three batteries, and seven batteries, respectively, and the capacity retention ratio also decreased. When the melting point of the polymer is low, the bonding strength between the electrode plate and the separator tends to decrease due to heat generated during overcharge. The melting point of the polymer needs to be higher than or equal to 165° C. Note that although PVDF, P(VDF/HFP) and P(VDF/CTFE) with a melting point lower than or equal to 175° C. are only available at present, it is supposed that favorable results may also be obtained using these polymers with a melting point higher than or equal to 175° C. Although there are polymers having a melting point higher than or equal to 175° C. among fluorine-based polymers other than polyvinylidene fluoride-based polymers, many of them do not have good solubility in solvents and are difficult to be handled.

As shown in Comparative Examples 6 and 7, when the adhesive layer did not contain an inorganic solid filler, it was difficult to form a porous layer in the adhesive layer, and therefore the capacity retention ratio decreased. The adhesive layer needs to contain an inorganic solid filler.

As the polymer of the adhesive layer, it is possible to use polyvinylidene fluoride; a copolymer of vinylidene fluoride and hexafluoropropylene; a copolymer of vinylidene fluoride and chlorotrifluoroethylene; a copolymer of vinylidene fluoride, hexafluoropropylene and tetrafluoroethylene; etc., and it is preferable to use polyvinylidene fluoride from the point of view of ensuring porosity in the adhesive layer.

Moreover, as the inorganic solid filler for use in the adhesive layer, although it is possible to use oxides such as Al₂O₃, SiO₂ and TiO₂; carbides such as SiC, B₄C and ZrC; and nitrides such as SiN and TiN, etc., one having a mean particle diameter smaller than or equal to 1 μm is preferred. Further, from the point of view of flexibility and dispersibility in preparing the slurry, it is preferable to use oxides such as Al₂O₃ and SiO₂.

As this invention may be embodied in several forms without departing from the spirit of essential characteristics thereof, the present embodiment is therefore illustrative and not restrictive, since the scope of the invention is defined by the appended claims rather than by the description preceding them, and all changes that fall within metes and bounds of the claims, or equivalence of such metes and bounds thereof are therefore intended to be embraced by the claims.

1. A non-aqueous electrolyte battery comprising:
a positive electrode plate;
a negative electrode plate; and
a separator bonded with an adhesive layer between the positive electrode plate and the negative electrode plate,
wherein the adhesive layer contains a fluorine-based polymer having a mass average molecular weight of from 500,000 to 1,500,000 and a melting point of from 165° C. to 175° C., and an inorganic solid filler.

2. The non-aqueous electrolyte battery according to claim 1, wherein the fluorine-based polymer is a polyvinylidene fluoride-based polymer.

3. The non-aqueous electrolyte battery according to claim 2, wherein the polyvinylidene fluoride-based polymer is a polyvinylidene fluoride homopolymer.

4. The non-aqueous electrolyte battery according to claim 1, wherein a particle size of the inorganic solid filler is smaller than or equal to 1 μm.

5. The non-aqueous electrolyte battery according to claim 1, wherein the inorganic solid filler contains an oxide, such as Al₂O₃, SiO₂ and TiO₂.
